(19) United States
(12) Patent Application Publication
(10) Pub. No.: US 2021/0123754 A1
(43) Pub. Date: Apr. 29, 2021

(54) METHOD FOR UNSUPERVISED AUTOMATIC ALIGNMENT OF VEHICLE SENSORS

(71) Applicant: GM GLOBAL TECHNOLOGY OPERATIONS LLC, Detroit, MI (US)

(72) Inventors: Emanuel Mordechai, Mishmarot (IL); Michael Slutsky, Kfar Saba (IL)

(21) Appl. No.: 16/663,706

(22) Filed: Oct. 25, 2019

(51) Int. Cl. G01C 21/34; G05D 1/00; G06F 17/16; H04W 4/02

(52) U.S. Cl. CPC G01C 21/3453; G05D 1/0088; G05D 2201/0213; H04W 4/026; G06F 17/16

(57) ABSTRACT

A vehicle, system and method for aligning a sensor with the vehicle. A first inertial measurement unit (IMU) associated with the vehicle obtains a first measurement of a kinematic vector of the vehicle. A second IMU associated with the sensor obtains a second measurement of the kinematic vector. A processor determines a current relative orientation between a first reference frame associated with the vehicle and a second reference frame associated with the sensor from the kinematic vector, determines an alignment error between the sensor and the vehicle based on the current relative orientation and a specified relative orientation, and adjusts the sensor from the current relative orientation to the specified relative orientation to correct for the alignment error.

### INTRODUCTION

The subject disclosure relates to vehicle sensors and, in particular, to a system and method for automatically aligning vehicle sensors.

Autonomous, semi-autonomous and driver-assisted vehicles use sensors such as Lidar, radar, camera, etc. in order to obtain measurements of the surroundings of a vehicle. Such measurements are then used by a processor or navigation system of the vehicle in order to control operation and navigation of the vehicle. Proper geometric alignment of these sensors is important to providing self-consistent data to the processor or navigation system. However, normal use and wear of the vehicle can lead to these sensors losing alignment over time. Accordingly, it is desirable to provide a system and method for realigning these sensors automatically.

### SUMMARY

In one exemplary embodiment, a method for aligning a sensor with a vehicle is disclosed. A first measurement of a kinematic vector of the vehicle is obtained at a first inertial measurement unit (IMU) associated with the vehicle. A second measurement of the kinematic vector is obtained at a second IMU associated with the sensor. A current relative orientation between a first reference frame associated with the vehicle and a second reference frame associated with the sensor is determined from the kinematic vector. An alignment error between the sensor and the vehicle is determined based on the current relative orientation and a specified relative orientation. The sensor is adjusted to the specified relative orientation to correct for the alignment error.

In addition to one or more of the features described herein, determining the current relative orientation further includes determining a rotation matrix for rotating the first reference frame into the second reference frame. Determining the rotation matrix further includes reducing a cost function. The cost function includes a difference between the first measurement of the kinematic vector in the first reference frame and a rotation of the second measurement of the kinematic vector. In various embodiments, the first measurement of the kinematic vector is obtained at a first time and the second measurement of the kinematic vector is obtained at a second time. The kinematic vector is at least one of an acceleration vector and an angular velocity vector. The first IMU is associated with one of the vehicle and another sensor.

In another exemplary embodiment, a system for aligning a sensor with a vehicle is disclosed. The system includes a first inertial measurement unit (IMU) associated with the vehicle, the first IMU configured to obtain a first measurement of a kinematic vector of the vehicle, a second IMU associated with the sensor, the second IMU configured to obtain a second measurement of the kinematic vector, and a processor. The processor is configured to determine a current relative orientation between a first reference frame associated with the vehicle and a second reference frame associated with the sensor from the kinematic vector, determine an alignment error between the sensor and the vehicle based on the current relative orientation and a specified relative orientation, and adjust the sensor from the current relative orientation to the specified relative orientation to correct for the alignment error.

In addition to one or more of the features described herein, the processor is further configured to determine the current relative orientation by determining a rotation matrix for rotating the first reference frame into the second reference frame. The processor is further configured to determine the rotation matrix by reducing a cost function. The cost function includes a difference between the first measurement of the kinematic vector and a rotation of the second measurement of the kinematic vector. The processor is further configured to obtain the first measurement at a first time and obtain the second measurement at a second time. The kinematic vector is at least one of an acceleration vector and an angular velocity vector. The first IMU is associated with one of the vehicle and another sensor.

In yet another exemplary embodiment, a vehicle is disclosed. The vehicle includes a first inertial measurement unit (IMU) associated with the vehicle, the first IMU configured to obtain a first measurement of a kinematic vector of the vehicle, a second IMU associated with a sensor of the vehicle, the second IMU configured to obtain a second measurement of the kinematic vector, and a processor. The processor is configured to determine a current relative orientation between a first reference frame associated with the vehicle and a second reference frame associated with the sensor from the kinematic vector, determine an alignment error between the sensor and the vehicle based on the current relative orientation and a specified relative orientation, and adjust the sensor from the current relative orientation to the specified relative orientation to correct for the alignment error.

In addition to one or more of the features described herein, the processor is further configured to determine the current relative orientation by determining a rotation matrix for rotating the first reference frame into the second reference frame. The processor is further configured to determine the rotation matrix by reducing a cost function, the cost function including a difference between the first measurement of the kinematic vector and a rotation of the second measurement of the kinematic vector. The processor is further configured to obtain the first measurement at a first time and obtain the second measurement at a second time. The kinematic vector is at least one of an acceleration vector and an angular velocity vector. The first IMU is associated with one of the vehicle and another sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in an illustrative embodiment;

FIG. 2 shows a perspective view of the vehicle of FIG. 1;

FIG. 3 shows a flowchart illustrating a method for determining an alignment for a plurality of IMUs and their associated sensors;

FIG. 4 shows acceleration and angular velocity measurements in reference frames of different IMUs of the vehicle;

FIG. 5 shows a diagram illustrating a method for simulating kinematic vectors at two sensors/IMUs; and

FIG. 6 shows a three-dimensional graph illustrating the effects of noise and time delay on alignment error measurements.

### DETAILED DESCRIPTION

The following description is merely exemplary in nature and is not intended to limit the present disclosure, its application or uses. It should be understood that throughout the drawings, corresponding reference numerals indicate like or corresponding parts and features.

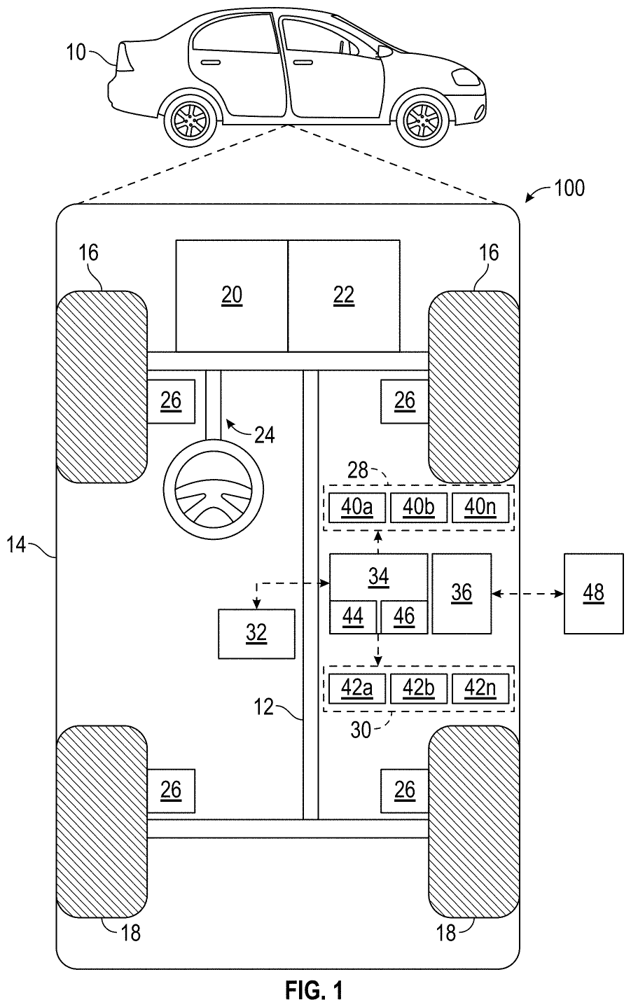

In accordance with an exemplary embodiment, FIG. 1 shows a vehicle 10. In an exemplary embodiment, the vehicle 10 is a semi-autonomous or autonomous vehicle. In various embodiments, the vehicle 10 includes at least one driver assistance system for both steering and acceleration/deceleration using information about the driving environment, such as cruise control and lane-centering. While the driver can be disengaged from physically operating the vehicle 10 by having his or her hands off the steering wheel and foot off the pedal at the same time, the driver must be ready to take control of the vehicle.

In general, a trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near respective corners of the body 14.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors for observing and measuring parameters of the exterior environment. The sensing devices 40a-40n may further include brake sensors, steering angle sensors, wheel speed sensors, etc. for observing and measuring in-vehicle parameters of the vehicle. The cameras can include two or more digital cameras spaced at a selected distance from each other, in which the two or more digital cameras are used to obtain stereoscopic images of the surrounding environment in order to obtain a three-dimensional image. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The at least one controller 34 includes at least one processor 44 and a computer readable storage device or media 46. The at least one processor 44 can be any custom made or commercially available processor, a central processing unit (CPU), a graphics processing unit (GPU), an auxiliary processor among several processors associated with the at least one controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the at least one controller 34 in controlling the vehicle 10.

The instructions may include one or more separate programs, each of which comprises an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller is shown in FIG. 1, embodiments of the vehicle 10 can include any number of controllers that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

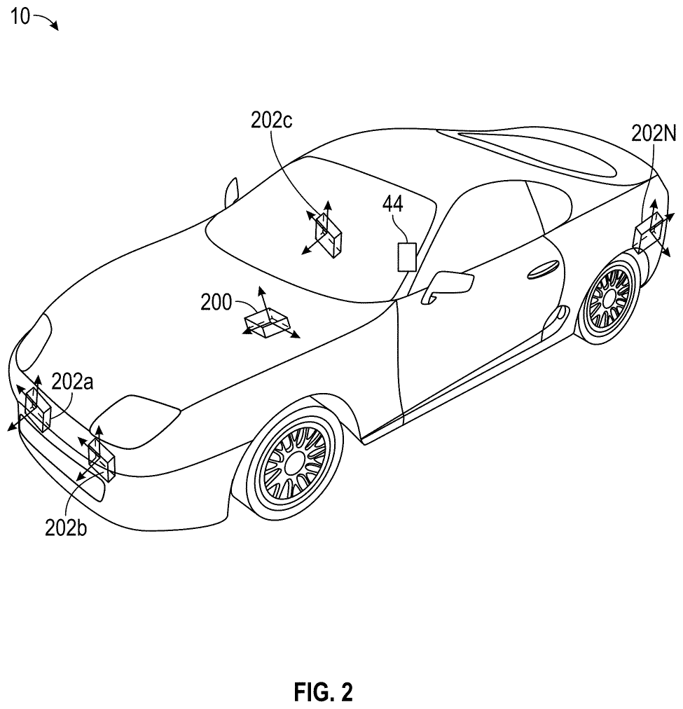

FIG. 2 shows a perspective view of the vehicle 10 of FIG. 1. The vehicle 10 includes a plurality of inertial measurement units (IMUs) which are capable of measuring kinematic parameters or kinematic vectors. The plurality of IMUS includes a vehicle-centered IMU 200 associated with the chassis 12 of the vehicle 10 and one or more sensor-centered IMUs 202a, 202b, 202c, . . . 202N. Each sensor-centered IMU 202a, 202b, 202c, . . . 202N is attached or coupled to an associated sensor. The sensors can include antennae, digital cameras, Lidar, radar, ultrasonic sensors, etc., that are used either for autonomous control of the vehicle or to aid a driver in operating the vehicle 10. Each sensor-centered IMU has one or more adjustment actuators for moving its associated sensor along three translational directions (x, y, z) and three angular directions (θ, φ, ψ) in order to adjust the alignment of its associated sensor. The plurality of IMUs are in communication with a processor 44 of the vehicle in order to send data regarding the kinematic parameter to the processor and to receive commands for using the adjustment actuators to adjust the alignment of its associated sensor. Although five IMUs are shown in FIG. 1 for illustrative purposes, any number of IMUs can be used in the vehicle.

Each IMU 200, 202a, 202b, 202c, . . . 202N includes kinematic sensors for measuring a kinematic vector. Each sensor-centered IMU 202a, 202b, 202c, . . . 202N measures the kinematic vector in a reference frame for its associated sensor, while the vehicle-centered IMU 200 measures the kinematic vector in a reference frame of the vehicle 10. In various embodiments, the kinematic vector includes an angular velocity vector and an acceleration vector A. An IMU can measure components of the kinematic vector in three-dimensions. The acceleration vector is a three-dimensional vector. However, the largest component of the acceleration vector is along a forward-axis direction while sideways acceleration and vertical acceleration are considerably smaller. Similarly, the angular velocity is a three-dimensional vector. However, the largest component of the angular velocity is a yaw rate component Q while pitch and roll component vectors are considerably smaller. Acceleration and angular velocity vectors are generally measured while the vehicle is in motion.

During vehicle motion, each IMU obtains measurements of the kinematic vector and registers its vector measurements at the processor 44. The processor 44 determines a current relative orientation between the vector measurements, thereby determining a current relative orientation between either a sensor and the chassis of the vehicle or between any two sensors. The current relative orientation can be compared to a specified orientation required for the sensors, thereby determining an alignment error. The processor 44 can then send a signal to a selected IMU, causing the selected IMU to activate one or more of its adjustment activators to adjust the sensor back to the specified orientation.

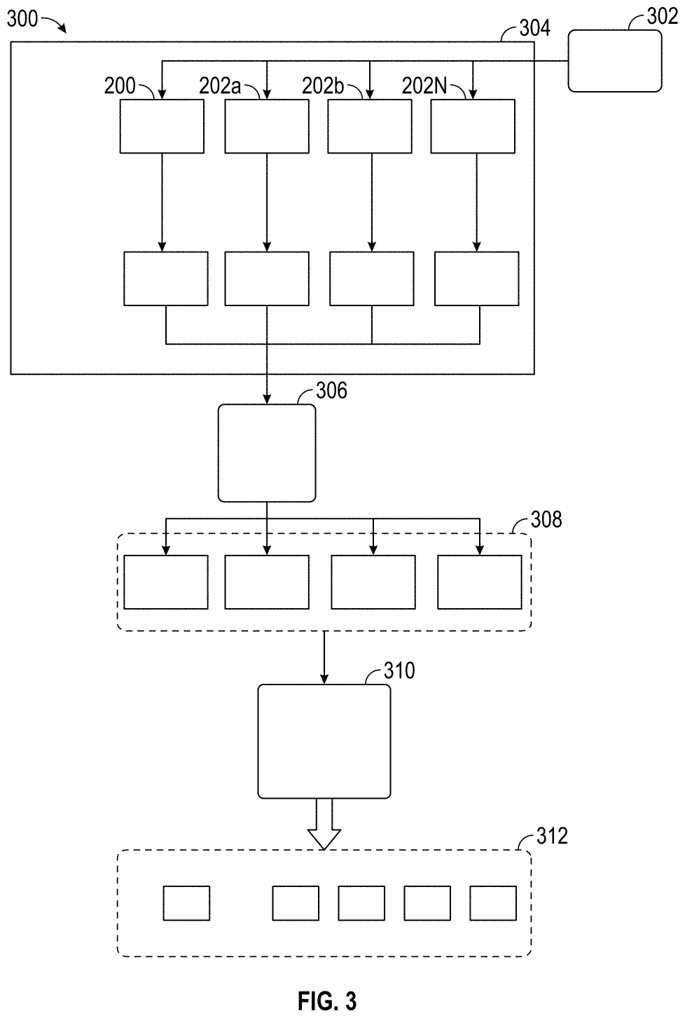

FIG. 3 shows a flowchart 300 illustrating a method for determining an alignment for the plurality of IMUs and their associated sensors. In box 302, the vehicle is placed in motion for an extended period of time. In box 304, each IMU is sampled in order to measure the kinematic parameter (i.e., acceleration and/or orientation). The IMUs can be sampled sequentially in time. In an illustrative embodiment, the vehicle IMU 200 is sampled at time t, to obtain A_vehicle(t) and Ω_vehicle(t). The first sensor IMU is sampled at time t+Δt₁ to obtain a_1(t+Δt₁) and Ω_1(t+Δt₁), the second sensor IMU is sampled at time t+Δt₂ to obtain a_2(t+Δt₂) and Ω_2(t+Δt₂), etc. The N^{th} sensor IMU is sampled at time t+Δt_{N} to obtain a_N(t+Δt_{N}) and Ω_N(t+Δt_{N}).

In box 306, a correlation function is applied to the kinematic measurements in order to resolve the differences in the kinematic vectors due to time differences between measurements. The results of the correlation function, shown in box 308, provides kinematic measurements for all sensors at time t (i.e., ((a_vehicle(t), Ω_vehicle(t)),. (a_1(t), Ω_1(t)), (a_2(t), Ω_2(t), . . . , (a_N(t), Ω_N(t))), as shown in box 308.

In box 310, rotation matrices are found between each sensor-centered IMU and the vehicle-centered IMU, using the time-corrected kinematic vectors obtained in box 308. A rotation matrix can be determined using the relevant kinematic vector. For example, the rotation matrix between the frame of reference (or “reference frame”) of the first IMU and the frame of reference of the vehicle can be found using (a_vehicle(t), 106 _vehicle(t)) and (a_1(t), Ω_1(t)). The current relative orientation of the first IMU to the vehicle chassis is therefore given by the rotation matrix. In box 312, relative rotation matrices Rᵢⱼ between any two sensor-based IMU can be determined from the rotation matrices found in box 310. Comparing the current relative orientation to the specified relative orientation yields an alignment error. The processor 44 can determine this alignment error and send a signal to the relevant IMUs in order to correct for the alignment error.

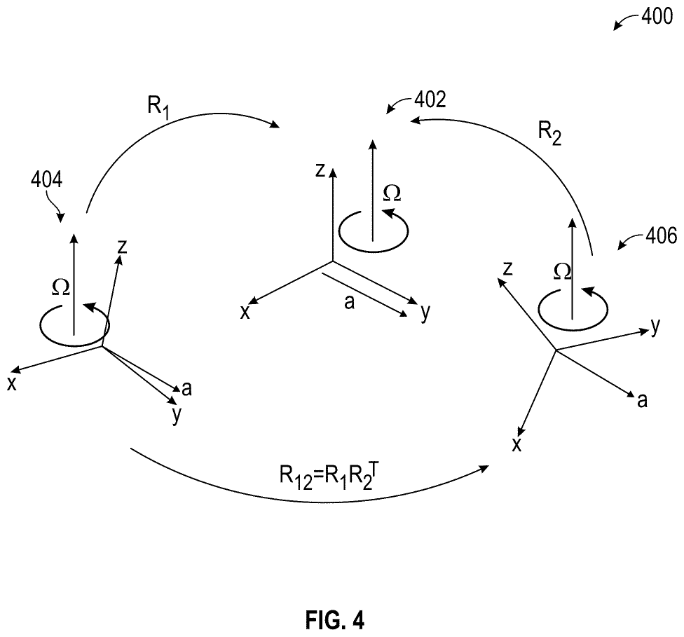

FIG. 4 shows acceleration and angular velocity measurements 400 in reference frames of different IMUs of the vehicle. For illustrative purposes, a vehicle frame of reference 402, a first sensor frame of reference 404 and a second sensor frame of reference 406 are shown. Each frame of reference is associated with an IMU. The angular velocity vector S2 of the vehicle and the acceleration vector A of the vehicle are shown in each of the three reference frames. While the angular velocity vector S2 of the vehicle and the acceleration vector A are the same regardless of reference frame, the measured value of these vectors in a reference frame depends on the orientation of the reference frame. The measurements of these vectors in each of the reference frames can thus be used to determine relative orientations between reference frames.

Referring to the illustrative example of FIG. 4, in the vehicle frame of reference 402, the angular velocity vector Ω is along a z-axis and the acceleration vector A is along the y-axis. In the first sensor frame of reference 404, the angular velocity vector Ω is at a small angle to the z-axis within the xz-plane, and the acceleration vector A is at a small angle to the y-axis within the yz-plane. In the second sensor frame of reference 406, the angular velocity vector Ω is at an angle to the z-axis within the yz-plane and the acceleration vector A is at an angle to the y-axis within the xy-plane.

A rotation matrix R₁ rotates the first sensor frame of reference 404 into alignment with the vehicle frame of reference 402. A rotation matrix R₂ rotates the second sensor frame of reference 406 into the vehicle frame of reference 402. Assuming orthogonality, a rotation matrix R₁R₂^{T} rotates the first sensor frame of reference 404 into the second sensor frame of reference 406.

Stated generally, acceleration vector aᵢ in the i^{th} sensor reference frame and angular velocity vector Ωᵢ in the i^{th} sensor reference frame are obtained by applying the rotation matrix Rᵢ to the acceleration vector A and angular velocity vector Ω in the vehicle frame of reference 402, as shown by Eq. (1):

aᵢ=Rᵢa Eq. (1)

and

Ωᵢ=RᵢΩ Eq. (2)

A rotation matrix between an i^{th} sensor frame of reference and a j^{th} sensor frame of reference is given by

aᵢ=Rᵢⱼaⱼ Eq. (3)

where

Rᵢⱼ=(θᵢⱼ, ϕᵢⱼ, ψᵢⱼ)=RᵢRⱼ⁻¹=RᵢRⱼ^{T} Eq. (4)

Given any two sets of measurements (e.g., m measurements {v^{(m)}}ᵢ in the i^{th} frame of reference and m measurements {v^{(m)}}ⱼ in the j^{th} frame of reference), the method disclosed herein determines a relative rotation matrix between the IMUᵢ of the i^{th} frame of reference and the IMUⱼ of the j^{th} frame of reference. The relative rotation matrix is determined by finding the values of the angular rotation variables that minimize or reduce a cost function (Eq. (5)):

\hat{θ}ᵢⱼ, \hat{ϕ}ᵢⱼ, \hat{ψ}ᵢⱼ=arg min[Φ(θᵢⱼ, ϕᵢⱼ, ψᵢⱼ)] Eq. (5)

where the cost function Φ is given by:

Φ(θᵢⱼ, ϕᵢⱼ, ψᵢⱼ)=Σₘ(vᵢ^{(m)}−Rᵢⱼvⱼ^{(m)})^{T}Πᵥ⁻¹(vᵢ^{(m)}−Rᵢⱼvⱼ^{(m)}) Eq. (6)

where the total covariance Πᵥ is calculated from measurement covariances Πᵥ⁽ⁱ⁾ adn Πᵥ⁽ⁱ⁾ as:

Πᵥ=Πᵥ⁽ⁱ⁾+RᵢⱼΠᵥ^{(j)}Rᵢⱼ^{T} Eq (7)

The calculations performed in Eqs. (5)-(7) can be extended to global alignment of a plurality of IMUs by including all corresponding measurements from all IMUs to obtain a cost function:

Φ_{g}=Σ_{i>j}Φ(θᵢⱼ, ϕᵢⱼ, ψᵢⱼ) Eq. (8)

and minimizing the cost function of Eq. (8) as indicated in Eqs. (5)-(7). This approach tends to distribute errors between the sensors and reduces the overall error propagation of the method.

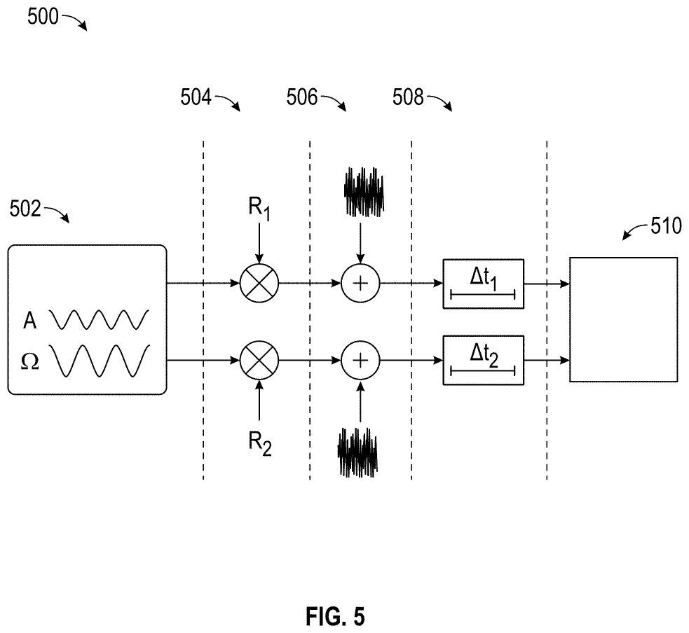

FIG. 5 shows a diagram 500 illustrating a method for simulating kinematic vectors at two sensors/IMUs. At stage 502, a reference IMU signal is generated. The reference IMUs signal can be a kinematic vector within the vehicle frame of reference and can include the acceleration vector and angular velocity vector. At stage 504, along one branch the reference IMU signal is rotated (via R₁) into a first sensor frame of reference to obtain a first rotated vector. Along another branch, the reference IMU signal is rotated (via R₂) into a second sensor frame of reference to obtain a second rotated vector. At stage 506, noise is added to each of the first rotated vector and the second rotated vector. At stage 508, a first random time delay is added to the first rotated vector and a second random time delay is added to the second rotated vector. The result, at stage 510 is a simulation of a signal measurement of the kinematic vectors (i.e., acceleration and angular velocity) at each of a first IMU and a second IMU.

The simulated signal measurements can be used to determine an estimate of a relative rotation matrix \hat{R}₁₂ between the first frame of the reference of the first IMU and the second frame of reference of the second IMU. An alignment error can then be determined based on the estimate \hat{R}₁₂ and the known rotation matrices R₁ and R₂ used in stage 504. The alignment error is therefore given as:

δR=(R₂R₁^{T})\hat{R}₁₂ Eq. (9)

By performing the simulation shown in FIG. 5 over multiple sensor orientations, a set of statistics can be obtained and the effect of noise and network delay on the alignment error can be determined.

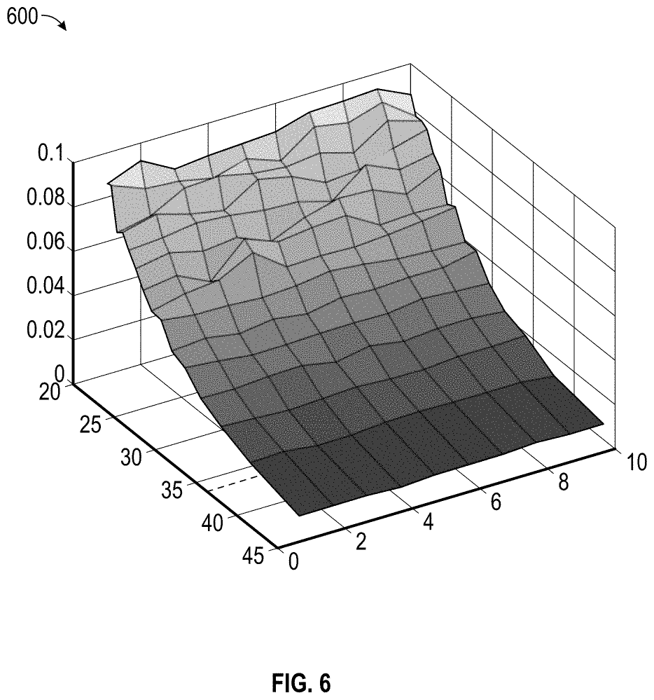

FIG. 6 shows a three-dimensional graph 600 illustrating the effects of noise and time delay on alignment error measurements. One axis of the graph 600 shows a maximum network delay in milliseconds. A second axis shows the signal-to-noise ratio (SNR) in decibels. The third axis shows a root mean squared alignment error in degrees. The alignment error is shown to be a minimum for high signal-to-noise ratios and small network delay. Increasing the network delay (up to about 10 milliseconds) has very little effect on increase the alignment error. However, as the signal-to noise ratio decreases (i.e., the signal becomes more noisy), the alignment error can increase. At a SNR of 20 decibels, the alignment error is about 0.1 degrees.

While the above disclosure has been described with reference to exemplary embodiments, it will be understood by those skilled in the art that various bchanges may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for aligning a sensor with a vehicle, comprising:
obtaining a first measurement, at a first inertial measurement unit (IMU) associated with the vehicle, of a kinematic vector of the vehicle;
obtaining a second measurement, at a second IMU associated with the sensor, of the kinematic vector;
determining a current relative orientation between a first reference frame associated with the vehicle and a second reference frame associated with the sensor from the kinematic vector;
determining an alignment error between the sensor and the vehicle based on the current relative orientation and a specified relative orientation; and
adjusting the sensor to the specified relative orientation to correct for the alignment error.

2. The method of claim 1, wherein determining the current relative orientation further comprises determining a rotation matrix for rotating the first reference frame into the second reference frame.

3. The method of claim 2, wherein determining the rotation matrix further comprises reducing a cost function.

4. The method of claim 3, wherein the cost function includes a difference between the first measurement of the kinematic vector in the first reference frame and a rotation of the second measurement of the kinematic vector.

5. The method of claim 1, further comprising obtaining the first measurement of the kinematic vector at a first time and obtaining the second measurement of the kinematic vector at a second time.

6. The method of claim 1, wherein the kinematic vector is at least one of an acceleration vector and an angular velocity vector.

7. The method of claim 1, wherein the first IMU is associated with one of the vehicle and another sensor.

8. A system for aligning a sensor with a vehicle, comprising:
a first inertial measurement unit (IMU) associated with the vehicle, the first IMU configured to obtain a first measurement of a kinematic vector of the vehicle;
a second IMU associated with the sensor, the second IMU configured to obtain a second measurement of the kinematic vector; and
a processor configured to:
determine a current relative orientation between a first reference frame associated with the vehicle and a second reference frame associated with the sensor from the kinematic vector;
determine an alignment error between the sensor and the vehicle based on the current relative orientation and a specified relative orientation; and
adjust the sensor from the current relative orientation to the specified relative orientation to correct for the alignment error.

9. The system of claim 8, wherein the processor is further configured to determine the current relative orientation by determining a rotation matrix for rotating the first reference frame into the second reference frame.

10. The system of claim 9, wherein the processor is further configured to determine the rotation matrix by reducing a cost function.

11. The system of claim 10, wherein the cost function includes a difference between the first measurement of the kinematic vector and a rotation of the second measurement of the kinematic vector.

12. The system of claim 8, wherein the processor is further configured to obtain the first measurement at a first time and obtain the second measurement at a second time.

13. The system of claim 8, wherein the kinematic vector is at least one of an acceleration vector and an angular velocity vector.

14. The system of claim 8, wherein the first IMU is associated with one of the vehicle and another sensor.

15. A vehicle, comprising:
a first inertial measurement unit (IMU) associated with the vehicle, the first IMU configured to obtain a first measurement of a kinematic vector of the vehicle;
a second IMU associated with a sensor of the vehicle, the second IMU configured to obtain a second measurement of the kinematic vector; and
a processor configured to:
determine a current relative orientation between a first reference frame associated with the vehicle and a second reference frame associated with the sensor from the kinematic vector;
determine an alignment error between the sensor and the vehicle based on the current relative orientation and a specified relative orientation; and
adjust the sensor from the current relative orientation to the specified relative orientation to correct for the alignment error.

16. The vehicle of claim 15, wherein the processor is further configured to determine the current relative orientation by determining a rotation matrix for rotating the first reference frame into the second reference frame.

17. The vehicle of claim 16, wherein the processor is further configured to determine the rotation matrix by reducing a cost function, the cost function including a difference between the first measurement of the kinematic vector and a rotation of the second measurement of the kinematic vector.

18. The vehicle of claim 15, wherein the processor is further configured to obtain the first measurement at a first time and obtain the second measurement at a second time.

19. The vehicle of claim 15, wherein the kinematic vector is at least one of an acceleration vector and an angular velocity vector.

20. The vehicle of claim 15, wherein the first IMU is associated with one of the vehicle and another sensor.
